(19) United States
(12) Patent Application Publication
(10) Pub. No.: US 2026/0174273 A1
(43) Pub. Date: Jun. 25, 2026

(54) BEVERAGE OR FOODSTUFF PREPARATION SYSTEM

(71) Applicant: SOCIÉTÉ DES PRODUITS NESTLÉ S.A., Vevey (CH)

(72) Inventor: André NOTH, Pully (CH)

(21) Appl. No.: 19/125,408

(22) PCT Filed: Nov. 2, 2023
(86) PCT No.: PCT/EP2023/080530

§ 371 Date: Apr. 29, 2025

(30) Foreign Application Priority Data
Nov. 4, 2022 (EP) 22205441.3
Nov. 4, 2022 (GB) 2216443.8

(51) Int. Cl. A47J 31/44; H04N 19/61

(52) U.S. Cl. CPC A47J 31/4492; H04N 19/61

(57) ABSTRACT

A container for containing a precursor material for use with a machine for preparing a beverage and/or foodstuff or a precursor thereof, the container including a machine-readable code storing preparation information for use with a preparation process performed by said machine, the code comprising: a reference portion (R) to locate the code, and; a data portion (D) to store the preparation information, wherein the reference portion comprises reference units arranged to uniquely define a linear virtual reference line (r), wherein the data portion comprises data units which at least partially encode values of parameters of the preparation information as geometric distances (d) of the data units from a start position along each of a plurality of virtual encoding lines (E), wherein said plurality of encoding lines are circular and are arranged to intersect the reference line (r), and an innermost encoding line has a smaller radii than an outermost encoding line, wherein: 1) an outermost encoding line encodes two or more values of the same parameter, which are encoded in a sequence according to an order of use of the parameter, each of said values being encoded with a single data unit arrangeable at any continuous position from a start position; 2) an innermost encoding line encodes a value of a parameter, which is encoded as an average distance of two data units from a start position, and; 3) said innermost encoding line encodes binary information of the preparation information, which is encoded as an absence or presence of a unit at a predetermined position with respect to one of the units encoding the parameter on the innermost encoding line.

### TECHNICAL FIELD

The present disclosure relates generally to electrically operated beverage or foodstuff preparation systems, with which a beverage or foodstuff is prepared from a pre-portioned capsule.

### BACKGROUND

Systems for the preparation of a beverage comprise a beverage preparation machine and a capsule. The capsule comprises a single-serving of a beverage forming precursor material, e.g. ground coffee or tea. The beverage preparation machine is arranged to execute a beverage preparation process on the capsule, typically by the exposure of pressurized, heated water to said precursor material. Processing of the capsule in this manner causes the at least partial extraction of the precursor material from the capsule as the beverage.

This configuration of beverage preparation machine has increased popularity due to 1) enhanced user convenience compared to a conventional beverage preparation machines (e.g. compared to a manually operated stove-top espresso maker) and 2) an enhanced beverage preparation process, wherein: preparation information encoded by a code on the capsule is read by the machine to define a recipe, and; the recipe is used by the machine to optimise the preparation process in a manner specific to the capsule. In particular, the encoded preparation information may comprise operating parameters selected in the beverage preparation process, including: fluid temperature; fluid pressure; preparation duration, and; fluid volume.

WO2016173735 A1 discloses a code arranged on a capsule. The code includes circular encoding lines on which data is encoded as a data unit arranged at an encoding distance from a start position on the encoding line.

WO2017144581 A1 discloses a code arranged on a capsule as well. The data portion may comprise one or more data units, thus encoding one or more parameters. In particular, as illustrated in FIG. 8E, the second reference position has three data units, each encoding a specific parameter, such as time, temperature, torque as the respective small, medium and large data units in particular positions, whereby these parameters represent triggers such that when a condition set by one of them is achieved then the phase encoded by the code is complete. As beverage preparation process increase in complexity, it is a challenge to encode a range of different data types of the preparation information on a code in a both accurate and computationally efficient manner.

Therefore, in spite of the effort already invested in the development of said systems further improvements are desirable.

### SUMMARY

The present disclosure provides a container for containing a precursor material for use with a machine for preparing a beverage or foodstuff or a precursor thereof, the container including a machine-readable code storing preparation information for use with a preparation process performed by said machine, in which the machine is controlled based on the preparation information to prepare said beverage and/or foodstuff or precursor thereof. As used herein reference to a “code” may include one or more repetitions of the code.

In embodiments, the container includes a body portion that has a storage portion for containing the precursor material and a closing member to close the storage portion (e.g. for a container arranged as a capsule). In embodiments, the code is arranged on the closing member. In embodiments, the storage portion includes a cavity that extends in a depth direction from the closing member. The container may have a maximum depth that is less than its diameter, which can be measured at the opening of the storage portion. In embodiments, the body portion includes a flange portion that connects the storage portion to the closing member. In embodiments, the cavity of the storage portion extends in a depth direction from the flange portion. The flange portion may present a generally planar peripheral rim for receiving the closing member. In embodiments, the flange portion is planar. As used herein the term “planar” in respect of the flange portion may refer to the flange portion arranged to extend entirely with the lateral and longitudinal directions, or substantially with said directions (e.g. with major components in these directions as opposed to a depth direction). In embodiments, the body portion is formed of walls that are joined at seams and/or folded (e.g. for a container arranged as a packet).

The embodiments, the code comprise a reference portion (R) to locate the code, and; a data portion (D) to store the preparation information, wherein the reference portion comprises reference units arranged to uniquely define a linear virtual reference line (r), wherein the data portion comprises data units which at least partially encode values of parameters of the preparation information as geometric distances (d) of the data units from a start position along each of a plurality of virtual encoding lines (E), wherein said plurality of encoding lines are circular and are arranged to intersect the reference line (r), and an innermost encoding line has a smaller radii than an outermost encoding line. In embodiments, an outermost encoding line encodes two or more values of the same parameter, each of said values being encoded with a single data unit arrangeable at any continuous position from a start position; an innermost encoding line encodes a value of a parameter, which is encoded as an average distance of two data units from a start position, and; said innermost encoding line encodes binary information of the preparation information, which is encoded as an absence or presence of a unit at a predetermined position with respect to one of the units encoding the parameter on the innermost encoding line.

By encoding the same parameters on an outermost encoding line with the data unit able to assume any continuous position from a start position (e.g. up to an end position), a greater circumferential distance of the outermost encoding line enables improved accuracy of the encoding distance, thus obviating a need to encode a value of a parameter with more than one data unit, which may otherwise be more computationally intensive to process. Moreover, by encoding different values of the same parameter on the outermost encoding line, the same accuracy in both values is obtained, e.g. compared to if one value was on an encoding line with a different radii.

By encoding a parameter on an innermost encoding line with two data units, a reduced circumferential distance of the innermost encoding line effecting reduced accuracy of the encoding distance is compensated for by improving the encoding accuracy with two units to encode a single value. Moreover, by encoding binary information on the innermost encoding line at predetermined positions, the reduced accuracy of the innermost encoding line is minimised on the binary information.

In embodiments, both of the data units encoding the parameter of the innermost encoding line are arrangeable at any continuous position from a start position (e.g. up to an end position) or both data units are each arrangeable at one of a predetermined number of positions arranged relative a start position with each position to designate a different value of the parameter.

In embodiments, the outermost encoding line encodes only values of parameters of the preparation information encoded with data units at any continuous distance from a start position (e.g. no encoding of binary information or of units at predetermined positions is present on the outermost encoding line).

In embodiments the two or more values of the same parameter of the outermost encoding line E1 are encoded in a sequence according to an order of use of the parameter.

As used herein the term “order of use” may refer to an order in which the value of the parameter is used by the processing unit when executing the preparation process. It may be desirable to arranged the values around the encoding line according to an order of use, since they maybe immediately implemented as they are decoded, rather than wait for all parameters to be decoded.

In embodiments, each of the two or more values of the same parameter encoded on the outermost encoding line are a time duration for which one or more components of a processing unit of the machine is operated. In embodiments a start position associated with a value comprises a data unit and a distance (d2) between said start position and a data unit encoding an adjacent value encodes a time duration between operations for which the component is not operated.

By implementing the data unit arranged at any continuous distance from a start position to encode a time for which a component is powered, and also with any continuous distance between the start position and a data unit of the neighbouring value encoding a time for which a component is not powered, a wide range of complex of/off operations may be encoded and accurately controlled.

In embodiments, the component is one or more of: a mixer of a mixing unit of the processing unit; a heat exchanger of a fluid conditioning system of the processing unit; a pump of the fluid conditioning system; a flow path control system of the fluid conditioning system.

As used herein the term “operated” in respect of a component of the processing unit may refer to one or more of: the component being powered; operated in a manner to perform an aspect of the preparation process, e.g. the powering of a thermal exchanger to heat fluid or a pump being powered to pump fluid or a mixer being operated to mix fluid; the opening and closing of a valve of a flow path control system.

In embodiments, an intermediate encoding line adjoining the outermost encoding line (e.g. it is directly next to with no other encoding lines therebetween) encodes a value of a further parameter which is encoded with a single data unit, which is: arrangeable at one of a predetermined number of positions (e.g. 6-12) arranged relative a start position with each position designate a different value of the parameter, or; is arrangeable at any continuous position from a start position.

By encoding parameters whose values assume discrete values rather than continuous values on non-outer encoding lines, the inaccuracy of the reduced radii of these encoding lines may have reduced effect on the values. Moreover, by arranging this encoding line proximal most the outermost encoding line, a single data unit may be used to encode a value, this is less computationally intensive than using two data units, and frees up more space for encoding other data.

In embodiments, the predetermined positions, encoding the further parameter of the intermediate encoding line adjoining the outermost encoding line, are arranged sequentially with each designating an increasing order of magnitude of the parameter. By implementing the predetermined positions in numerical order of parameter value magnitude, a read error where a parameter value is erroneously read as a value of a neighbouring predetermined position may have a minimised effect on the preparation process compared to an arbitrary arrangement.

In embodiments, the further parameter(s) encoded by the intermediate encoding line, adjoining the outermost encoding line, encode a setting of the component when operated (e.g. for each of the previously described on operations the setting as defined by the further parameter is the same). The setting for example may be a magnitude of operation (e.g. a temperature of the heat exchanger or a constant flow rate value of the pump or a flow control value associated with the fluid conditioning system) and/or a frequency of operation (e.g. a pulsing frequency of the thermal exchanger or the pump).

In embodiments, an intermediate encoding line, adjoining the outermost encoding line, encodes two or more values of the same parameter, said values each being encoded with a single data unit which is: arrangeable at one of a predetermined number of positions arranged relative a start position with each position designate a different value of the parameter, or; is arrangeable at any continuous position from a start position. By encoding different values of the same parameter on said intermediate encoding line, the same accuracy in both values is obtained, e.g. compared to if one value was on a encoding line with a different radii.

In embodiments, the two or more values of the same parameter are arranged in order to correspond and order of use to the two of more values of the parameter on the outermost encoding line. In embodiments, the two or more values encode a setting of the component when operated (e.g. for each of the previously described on operations the setting as defined by the further parameter is the different). In embodiments, the two or more values of the same parameter of the intermediate encoding line encode a flow rate of a pump of a fluid conditioning system of a processing unit, or a temperature of the thermal exchanger of the fluid conditioning system.

In embodiments, an intermediate encoding line adjoining the innermost encoding line (e.g. it is directly next to with no other encoding lines therebetween) encodes a value of a parameter, which is encoded as an average distance of two data units, from a start position on the intermediate encoding line. In embodiments, the intermediate encoding line adjoining the innermost encoding line encodes binary information, which is encoded as an absence or presence of a unit at a predetermined position with respect to one of the units encoding the parameter on the intermediate encoding line. In embodiments, the binary information comprises an identifier which is distributed over the innermost encoding line and said intermediate encoding line.

By encoding a parameter on an intermediate encoding line, which is proximal most the innermost encoding line, with two data units, a reduced circumferential distance of the intermediate encoding line which is proximal most the innermost encoding line causing reduced accuracy of the encoding distance is compensated for by improving the encoding accuracy with two units to encode a single encoding distance. Moreover, by encoding binary information on the innermost encoding line at predetermined positions, the reduced accuracy of said intermediate innermost encoding line is minimised on the binary information. By distributing the binary information over the two innermost encoding lines, an amount of binary information that is encoded can be increased without reduced accuracy (which would occur if there were too many predetermined positions on a single encoding line).

In embodiments, both of the data units of the intermediate encoding line adjoining the innermost encoding line are arrangeable at any continuous position from a start position (e.g. up to a maximum at an end position) or both data units are each arrangeable at one of a predetermined number of positions arranged relative a start position with each position designate a different value of the parameter.

In embodiments, the parameter encoded by the two data units of the innermost most encoding line and/or of the intermediate encoding line, which is proximal most the innermost encoding line, may be: a parameter associated with a closing force of an extraction unit (e.g. a force between a capsule holding portion and a closing portion); a displacement position of the extraction unit (e.g. a displacement of the capsule holding portion and/or the closing portion); a volume of fluid or fluid flow rate applied by a pump of a fluid condition system of the processing unit; a temperature of a heat exchanger of the fluid conditioning system, etc.

In embodiments, the binary information is additionally encoded as an absence or presence of a unit at vertices that define a square, with said vertices outside the outermost encoding line, and the binary information comprises the identifier.

By arranging the binary information at outer corners of the code, the formation of the code may be generally a square, which may enable large organised formations of individual codes in columns and rows with minimal wasted space therebetween providing a high information encoding density.

The present disclosure provides a substrate for attachment to a container for containing a precursor material or to a machine for use with a machine for preparing a beverage and/or foodstuff or a precursor thereof, the substrate comprising a code comprising any feature of the code of the preceding embodiments or another embodiment disclosed herein.

As used herein the term “substrate” may refer to any suitable carrier for the code that can be used to connect the code to a container, examples of which include: a sticker; a cardboard member to receive an adhesive strip, and; other suitable arrangements. In embodiments, the substrate is for attachment to the machine for preparing a beverage and/or foodstuff, or for implementation as a held component.

The present disclosure provides a code for: a container for containing a precursor material for use with a machine for preparing a beverage and/or foodstuff or a precursor thereof; or a machine for preparing a beverage and/or foodstuff or a precursor thereof. The code may comprise any feature of the code of the preceding embodiments, or another embodiment disclosed herein. The code may be arranged on a substrate for attachment to: said container, or; said machine, or; or other component, e.g. including a hand held component that is arranged for a user to present to a code reader of the machine.

The present disclosure provides a machine for preparing a beverage and/or foodstuff or a precursor thereof from the container of any preceding embodiment or another embodiment disclosed herein.

In embodiments, the machine comprises: a code reading system to read a code of a container; a processing unit for processing precursor material of the container, and; electrical circuitry to control the processing unit based on preparation information read from the code. The code reading system may include an image capturing unit (e.g. a camera).

As used herein the term “based on” in respect of the preparation information may refer to a direct relationship (e.g. a value of a parameter of a recipe is encoded directly on the code as the encoding distance, which may be converted to a value using a rule) or a rule is used via a stored relationship to look up one or more of said values using the preparation information as an identifier.

In embodiments, the processing unit includes a container processing unit and a fluid conditioning system, and; the electrical circuitry is arranged to control the container processing unit and fluid conditioning system based on the preparation information read from the code. In embodiments, the processing unit is arranged as a loose material processing unit, and; the electrical circuitry is arranged to control the loose material processing unit to process loose precursor material dispensed from the container or arranged in the container based on the preparation information read from the code.

In embodiments, the electrical circuitry of the machine implements a method of reading preparation information from a code as disclosed herein.

In embodiments, the electrical circuitry is implemented as one or more processors, which are configured to implement the disclosed steps performed by the code reading system and/or the steps performed by the processing unit for processing precursor material of the container. The processors may execute program code stored on electronic memory and/or may execute programable logic, e.g., as a logic array, gate array, structured array etc.

The present disclosure provides a system comprising the container of any preceding embodiment or another embodiment disclosed herein and a machine for preparing a beverage and/or foodstuff or a precursor thereof according to any preceding embodiment or another embodiment disclosed herein.

The present disclosure provides use of the container of any preceding embodiment or another embodiment disclosed herein for a machine for preparing a beverage and/or foodstuff or a precursor thereof according to any preceding embodiment or another embodiment disclosed herein.

The present disclosure provides a method of encoding preparation information with a code, which may be arranged on a container. The method may implement the features of any preceding embodiment or another embodiment disclosed herein.

In embodiments, the method comprises arranging reference units of the code to define a reference portion (R) to locate the code, wherein the reference portion is arranged to define a linear virtual reference line (r); encoding, on an outermost circular encoding line (E) of a data portion (D), two or more values of a same parameter of the preparation information, said values encoded in a sequence according to an order of use of the parameter, said values being encoded as a single data unit arrangeable at any continuous position from a start position on the encoding line as a geometric distance (d) along the encoding line; encoding, on an innermost circular encoding line (E) of the data portion (D), a value of a parameter of the preparation information, said value encoded as an average distance of two data units, both of which are arranged from a start position on the encoding line as a geometric distance (d) along the encoding line; encoding, on the inner circular encoding line (E) binary information of the preparation information, which is encoded as an absence or presence of a unit at a predetermined position on the encoding line with respect to one of the units encoding the parameter on the innermost encoding line.

In embodiments, the method comprises encoding a further parameter on an intermediate encoding line, which encodes a setting of a component of a processing unit when operated, wherein a value for the outermost encoding line encodes a time for which said component is operated.

In embodiments, the method comprises encoding an identifier as binary information over more than one encoding line.

The present disclosure provides a method of reading preparation information from a code for use in a preparation process, in which a machine is controlled based on the preparation information to prepare a beverage and/or foodstuff or precursor thereof. The method may implement the features of any preceding embodiment or another embodiment disclosed herein.

In embodiments, the method comprises: locating a reference portion (R) of the code; locating a data portion (D) of the code using a linear line defined by the reference portion (R); reading from an outermost circular encoding line (E) of the data portion (D), two or more encoded values of a same parameter of the preparation information, said values encoded in a sequence according to an order of use of the parameter, said values being encoded as a single data unit arrangeable at any continuous position from a start position on the encoding line as a geometric distance (d) along the encoding line; reading from an innermost circular encoding line (E) of a data portion (D), an encoded value of a parameter of the preparation information, said value encoded as an average distance of two data units, both of which are arranged from a start position on the encoding line as a geometric distance (d) along the encoding line; reading on the innermost circular encoding line (E) binary information of the preparation information, which is encoded as an absence or presence of a unit at a predetermined position on the encoding line with respect to one of the units encoding the parameter on the innermost encoding line.

In embodiments, the method comprises reading a further parameter from an intermediate encoding line, which encodes a setting of a component of a processing unit when operated wherein a value for the outermost encoding line encodes a time for which said component is operated.

In embodiments, the method comprises reading an identifier as binary information encoded over more than one encoding line.

The method may be implemented as part of a method of preparing a beverage or foodstuff or a precursor thereof, in which a processing unit is controlled based on the preparation information to execute a preparation process on the precursor material.

The present disclosure provides electrical circuitry to implement the method of the preceding embodiments or another embodiment disclosed herein.

The present disclosure provides a computer readable medium comprising program code, which may be executable on one or more processors, to implement the method of the preceding embodiments or another embodiment disclosed herein.

The preceding summary is provided for purposes of summarizing some embodiments to provide a basic understanding of aspects of the subject matter described herein. Accordingly, the above-described features are merely examples and should not be construed to narrow the scope or spirit of the subject matter described herein in any way. Moreover, the above and/or proceeding embodiments may be combined in any suitable combination to provide further embodiments.

Other features, aspects, and advantages of the subject matter described herein will become apparent from the following Detailed Description of Embodiments, Brief Description of Figures, and Claims.

### BRIEF DESCRIPTION OF FIGURES

Aspects, features and advantages of embodiments of the present disclosure will become apparent from the following detailed description of embodiments in reference to the appended drawings in which like numerals denote like elements.

FIG. 1 is a block system diagram showing an embodiment system for preparation of a beverage or foodstuff.

FIG. 2 is a block system diagram showing an embodiment machine of the system of FIG. 1.

FIG. 3 is an illustrative diagram showing an embodiment fluid conditioning system of the machine of FIG. 2.

FIGS. 4 and 5 are illustrative diagrams showing an embodiment container processing system of the machine of FIG. 2 on open and closed positions.

FIG. 6 is an illustrative diagram showing an embodiment machine of FIG. 2, which comprises a loose material processing unit.

FIG. 7 is a block diagram showing embodiment control electrical circuitry of the machine of FIG. 2.

FIGS. 8 and 9 are illustrative diagrams showing embodiment containers of the system of FIG. 1.

FIG. 10 is flow diagram showing an embodiment preparation process, which is performed by the system of FIG. 1.

FIG. 11 is a plan view showing an embodiment code of the containers of the system of FIG. 1.

FIGS. 12 and 13 are flow diagrams showing embodiment processes for extracting preparation information from the code of FIG. 11.

FIGS. 14 and 15 are plan views showing embodiments of the code of FIG. 11.

### DETAILED DESCRIPTION OF EMBODIMENTS

Before describing several embodiments of the system, it is to be understood that the system is not limited to the details of construction or process steps set forth in the following description. It will be apparent to those skilled in the art having the benefit of the present disclosure that the system is capable of other embodiments and of being practiced or being carried out in various ways.

The present disclosure may be better understood in view of the following explanations:

As used herein, the term “machine” may refer to an electrically operated device that: can prepare, from a precursor material, a beverage and/or foodstuff, or; can prepare, from a pre-precursor material, a precursor material that can be subsequently prepared into a beverage and/or foodstuff. The machine may implement said preparation by one or more of the following processes: dilution; heating; cooling; mixing; whisking; dissolution; soaking; steeping; extraction; conditioning; infusion; grinding, and; other like process. The machine may be dimensioned for use on a work top, e.g. it may be less than 70 cm in length, width and height. As used herein, the term “prepare” in respect of a beverage and/or foodstuff may refer to the preparation of at least part of the beverage and/or foodstuff (e.g. a beverage is prepared by said machine in its entirety or part prepared to which the end-user may manually add extra fluid prior to consumption, including milk and/or water).

As used herein, the term “container” may refer to any configuration to contain the precursor material, e.g. as a single-serving, pre-portioned amount. The container may have a maximum capacity such that it can only contain a single-serving of precursor material. The container may be single use, e.g. it is physically altered after a preparation process, which can include one or more of: perforation to supply fluid to the precursor material; perforation to supply the beverage/foodstuff from the container; opening by a user to extract the precursor material. The container may be configured for operation with a container processing unit of the machine, e.g. it may include a flange for alignment and directing the container through or arrangement on said unit. The container may include a rupturing portion, which is arranged to rupture when subject to a particular pressure to deliver the beverage/foodstuff. The container may have a membrane for closing the container. The container may have various forms, including one or more of: frustoconical; cylindrical; disk; hemispherical; packet; other like form. The container may be formed from various materials, such as metal or plastic or paper or a combination thereof. The material may be selected such that it is one or more of: food-safe; it can withstand the pressure and/or temperature of a preparation process, and; it is biodegradable. The container may be defined as a capsule, wherein a capsule may have an internal volume of 20-100 ml. The capsule includes a coffee capsule, e.g. a Nespresso® or Nescafé® capsule (including a Classic, Professional, Vertuo, Dolce Gusto or other capsule). The container may be defined as a receptacle, wherein a receptacle may have an internal volume of 150-350 ml. The receptacle is typically for end user consumption therefrom, and includes a pot, for consumption via an implement including a spoon, and a cup for drinking from. The container may be defined as a packet, wherein the packet is formed from a flexible material, including plastic or foil. A packet may have an internal volume of 150-350 ml or 200-300 ml or 50-150 ml.

As used herein, the term “external device” or “external electronic device” or “peripheral device” may include electronic components external to the machine, e.g. those arranged at a same location as the machine or those remote from the machine, which communicate with the machine over a computer network. The external device may comprise a communication interface for communication with the machine and/or a server system. The external device may comprise devices including: a smartphone; a PDA; a video game controller; a tablet; a laptop; or other like device.

As used herein, the term “server system” may refer to electronic components external to the machine, e.g. those arranged at a remote location from the machine, which communicate with the machine over a computer network. The server system may comprise a communication interface for communication with the machine and/or the external device. The server system can include: a networked-based computer (e.g. a remote server); a cloud-based computer; any other server system.

As used herein, the term “system” or “beverage or foodstuff preparation system” may refer to the combination of any two of more of: the beverage or foodstuff preparation machine; the container; the server system, and; the peripheral device.

As used herein, the term “beverage” may refer to any substance capable of being processed to a potable substance, which may be chilled or hot. The beverage may be one or more of: a solid (e.g. a solid suspended in a liquid); a liquid; a gel; a paste. The beverage may include one or a combination of: tea; coffee; hot chocolate; milk; cordial; vitamin composition; herbal tea/infusion; infused/flavoured water, and; other substance. As used herein, the term “foodstuff” may refer to any substance capable of being processed to a nutriment for eating, which may be chilled or hot. The foodstuff may be one or more of: a solid; a liquid; a gel; a paste. The foodstuff may include: yoghurt; mousse; parfait; soup; ice cream; sorbet; custard; smoothies; other substance. It will be appreciated that there is a degree of overlap between the definitions of a beverage and foodstuff, e.g. a beverage can also be a foodstuff and thus a machine that is said to prepare a beverage or foodstuff does not preclude the preparation of both.

As used herein, the term “precursor material” may refer to any material capable of being processed to form part or all of the beverage or foodstuff. The precursor material can be one or more of a: powder; crystalline; liquid; gel; solid, and; other. Examples of a beverage forming precursor material include: ground coffee; milk powder; tea leaves; coco powder; vitamin composition; herbs, e.g. for forming a herbal/infusion tea; a flavouring, and; other like material. Examples of a foodstuff forming precursor material include: dried vegetables or stock as anhydrous soup powder; powdered milk; flour based powders including custard; powdered yoghurt or ice-cream, and; other like material. A precursor material may also refer to any pre-precursor material capable of being processed to a precursor material as defined above, i.e. any precursor material that can subsequently be processed to a beverage and/or foodstuff. In an example, the pre-precursor material includes coffee beans which can be ground and/or heated (e.g. roasted) to the precursor material.

A precursor material may also refer to any pre-precursor material capable of being processed to a precursor material as defined above, i.e. any precursor material that can subsequently be processed to a beverage and/or foodstuff. In an example, the pre-precursor material includes coffee beans which can be ground and/or heated (e.g. roasted) to the precursor material.

As used herein, the term “fluid” (in respect of fluid supplied by a fluid conditioning system) may include one or more of: water; milk; other. As used herein, the term “conditioning” in respect of a fluid may refer to to change a physical property thereof and can include one or more of the following: heating or cooling; agitation (including frothing via whipping to introduce bubbles and mixing to introduce turbulence); portioning to a single-serving amount suitable for use with a single serving container; pressurisation e.g. to a brewing pressure; carbonating; fliting/purifying, and; other conditioning process.

As used herein, the term “processing unit” may refer to an arrangement that can process precursor material to a beverage or foodstuff. It may refer to an arrangement that can process a pre-precursor material to a precursor material.

As used herein, the term “container processing unit” may refer to an arrangement that can process a container to derive an associated beverage or foodstuff from a precursor material. The container processing unit may be arranged to process the precursor material by one of more of the following: dilution; heating; cooling; mixing; whisking; dissolution; soaking; steeping; extraction; conditioning; pressurisation; infusion, and: other processing step. The container processing unit may therefore implement a range of units depending on the processing step, which can include: an extraction unit (which may implement a pressurised and/or a thermal, e.g. heating or cooling, brewing process); a mixing unit (which mixes a beverage or foodstuff in a receptacle for end user consumption therefore; a dispensing and dissolution unit (which extracts a portion of the precursor material from a repository, processes by dissolution and dispenses it into a receptacle), and: other like unit.

As used herein, the term “loose material processing unit” may refer to an arrangement that can process loose material of a pre-precursor material to a precursor material. The loose material processing unit may be arranged to process the pre-precursor material by one of more of the following: heating; cooling; grinding; mixing; soaking; conditioning; other processing step. The loose material may be supplied to the loose material processing unit in a container, from which it is extracted and processed.

As used herein, the term “preparation process” may refer to a process to prepare a beverage or foodstuff from a precursor material or to prepare a pre-precursor material from precursor material. A preparation process may refer to the processes electrical circuitry executes to control the container processing unit to process said precursor or pre-precursor material.

As used herein, the term “electrical circuitry” or “circuitry” or “control electrical circuitry” may refer to one or more hardware and/or software components, examples of which may include on or more of: an Application Specific Integrated Circuit (ASIC) or other logic gate structures; electronic/electrical componentry (which may include combinations of transistors, resistors, capacitors, inductors etc); one or more processors (e.g. the electrical circuitry may refer to the structure of the processor); a non-transitory memory (e.g. implemented by one or more memory devices), that may store one or more software or firmware programs; a combinational logic circuit; interconnection of the aforesaid. The electrical circuitry may be located entirely at the machine, or distributed between one or more of: the machine; external devices; a server system.

As used herein, the term “processor” or “processing resource” may refer to one or more units for processing, examples of which include an ASIC, microcontroller, FPGA, microprocessor, digital signal processor (DSP), state machine or other suitable component. A processor may be configured to execute a computer program, e.g. which may take the form of machine readable instructions, which may be stored on a non-transitory memory and/or programmable logic. The processor may have various arrangements corresponding to those discussed for the circuitry, e.g. on-board machine or distributed as part of the system. As used herein, any machine executable instructions, or computer readable media, may be configured to cause a disclosed method to be carried out, e.g. by the machine or system as disclosed herein, and may therefore be used synonymously with the term method, or each other.

As used herein, the term “computer readable medium/media” or “data storage” may include any medium capable of storing a computer program, and may take the form of any conventional non-transitory memory, for example one or more of: random access memory (RAM); a CD; a hard drive; a solid state drive; a memory card; a DVD. The memory may have various arrangements corresponding to those discussed for the circuitry.

As used herein, the term “communication resources” or “communication interface” may refer to hardware and/or firmware for electronic information transfer. The communication resources/interface may be configured for wired communication (“wired communication resources/interface”) or wireless communication (“wireless communication resources/interface”). Wireless communication resources may include hardware to transmit and receive signals by radio and may include various protocol implementations e.g. the 802.11 standard described in the Institute of Electronics Engineers (IEEE) and Bluetooth™ from the Bluetooth Special Interest Group of Kirkland Wash. Wired communication resources may include; Universal Serial Bus (USB); High-Definition Multimedia Interface (HDMI) or other protocol implementations. The machine may include communication resources for wired or wireless communication with an external device and/or server system.

As used herein, the term “network” or “computer network” may refer to a system for electronic information transfer between a plurality of apparatuses/devices. The network may, for example, include one or more networks of any type, which may include: a Public Land Mobile Network (PLMN); a telephone network (e.g. a Public Switched Telephone Network (PSTN) and/or a wireless network); a local area network (LAN); a metropolitan area network (MAN); a wide area network (WAN); an Internet Protocol Multimedia Subsystem (IMS) network; a private network; the Internet; an intranet.

As used herein, the term “code” may refer to a storage medium that encodes preparation information. The code may be formed of a plurality of units, which can be referred to as elements or markers. The elements may implement a reference portion and a data portion, wherein the reference portion enables location of the data portion, which encodes the preparation information. The code may be arranged as a two dimensional code, which is processed via a digital image obtained from a camera of the code reader. It will be understood that a code may therefore exclude a mere surface finish or branding on a container, which is not configured in any way for information storage.

As used herein the term “preparation information” may refer to one of more of: a parameter having a value as defined herein; a recipe as defined herein; an identifier use to look-up one or more parameters, all of which maybe used to control the processing unit or other component for processing the precursor material. The identifier may be encoded as binary information where an absence or presence of a unit at a position designates a logical 1 or 0.

As used herein, the term “parameter” may refer to a variable that is used as an input for controlling (e.g. RPM) and/or or a property of the beverage/foodstuff or a precursor thereof that is controlled by the processing unit (e.g. a fluid target temperature or volume) during the preparation process. Depending on the implementation of the processing unit said parameter may vary. Examples include: volume of a particular component of the beverage and/or foodstuff; fluid temperature; fluid flow rate; operational parameters of the processing unit, e.g. RPM of an extraction unit based on centrifugation or closing force for a hydraulic brewing unit; an order of dispensing of components of the beverage and/or foodstuff; time of operation, e.g. for a pump or heat exchanger; agitation (e.g. frothing degree); any of the aforesaid defined for one or more phases, wherein the preparation process is composed of a series of sequential, discrete phases. The parameters that may be associated container processing unit that comprises a loose material processing unit, can include one or more of: grinding parameters, including intensity; heating temperature. The parameter may have a value, which may be numerical and can vary in predetermined increments between predetermined limits, e.g. a temperature of the water may vary between 60-90 degrees in 5 degree increments.

As used herein, the term “recipe” or “control data set” may refer to a combination of said parameters, e.g. as a full or partial set of inputs, that are used by the processing unit to prepare a particular beverage and/or food stuff.

As used herein, the term “preparation process” may refer to a process to prepare a beverage or foodstuff from a precursor material or to prepare a pre-precursor material from precursor material. A preparation process may refer to the processes electrical circuitry executes to control the processing unit to process said precursor or pre-precursor material.

As used herein, the term “code reading process” may refer to the process of reading the code to extract the preparation information (which can include the identifier and/or parameters). The process may include one or more of the following steps: obtaining a digital image of the code or a code signal; extracting a sequence of bits from the code; identifying a finder portion of the code in the sequence; locating a data portion using the finder portion, and; extracting the preparation information from the data portion.

### [General System Description]

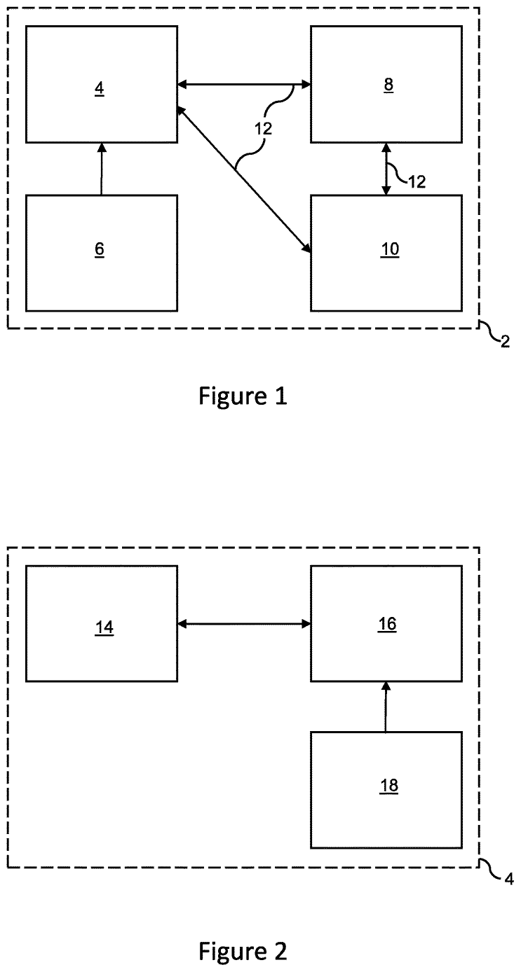

Referring to FIG. 1, the system 2 comprises a machine 4, a container 6, server system 8 and a peripheral device 10. The server system 8 is in communication with the machine 4 via a computer network 12. The peripheral device 10 is in communication with the machine 4 via the computer network 12.

In variant embodiments, which are not illustrated: the peripheral device and/or server system is omitted.

Although the computer network 12 is illustrated as the same between the machine 4, server system 8 and peripheral device 10, other configurations are possible, including: a different computer network for intercommunication between each device: the server system communicates with the machine via the peripheral device rather than directly. In a particular example: the peripheral device communicates with the machine via a wireless interface, e.g. with a Bluetooth™ protocol, and; the server system communicates with the machine via a via a wireless interface, e.g. with a IEE 802.11 standard, and also via the internet.

### [Machine]

Referring to FIG. 2, the machine 4 comprises: a processing unit 14 for processing the precursor material; electrical circuitry 16, and; a code reading system 18.

The electrical circuitry 16 controls the code reading system 18 to read a code (not illustrated in FIG. 2) from the container 6 and determine preparation information therefrom. The electrical circuitry 16 uses the preparation information to control the processing unit 14 to execute a preparation process, in which the precursor material is process to a beverage or foodstuff or a precursor thereof.

### [First Example of Processing Unit]

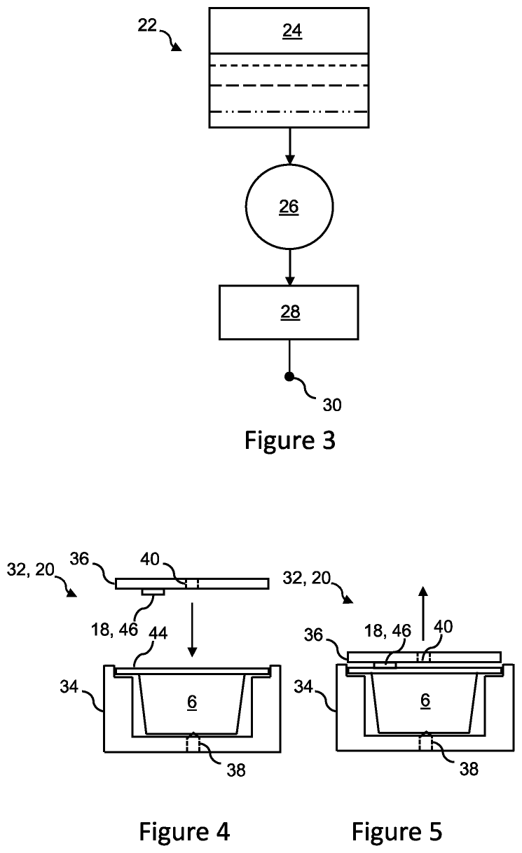

Referring to FIGS. 3, 4 and 5, in a first example of the processing unit 14, said unit comprises a container processing unit 20 and a fluid conditioning system 22.

The container processing unit 20 is arranged to process the container 6 to derive a beverage or foodstuff from precursor material (not illustrated) therein. The fluid conditioning system 22 conditions fluid supplied to the container processing unit 20. The electrical circuitry 16 uses the preparation information read from the container 6 to control the container processing unit 20 and the fluid conditioning system 22 to execute the preparation process.

### [Fluid Conditioning System]

Referring to FIG. 3, the fluid conditioning system 22 includes a reservoir 24; pump 26; heat exchanger 28, and; an outlet 30 for the conditioned fluid. The reservoir 24 contains fluid, typically sufficient for multiple preparation processes. The pump 26 displaces fluid from the reservoir 24, through the heat exchanger 26 and to the outlet 30 (which is connected to the container processing unit 20). The pump 26 can be implement as any suitable device to drive fluid, including: a reciprocating; a rotary pump; other suitable arrangement. The heat exchanger 28 is implemented to heat the fluid, and can include: an in-line, thermo block type heater; a heating element to heat the fluid directly in the reservoir; other suitable arrangement.

In variant embodiments, which are not illustrated: the pump is omitted, e.g. the fluid is fed by gravity to the container processing unit or is pressurised by a mains water supply; the reservoir is omitted, e.g. water is supplied by a mains water supply; the heat exchanger is arranged to cool the fluid, e.g. it may include a refrigeration-type cycle heat pump; the heat exchanger is omitted, e.g. a mains water supply supplies the water at the desired temperature; the fluid conditioning system includes a filtering/purification system, e.g. a UV light system, a degree of which that is applied to the fluid is controllable; a carbonation system that controls a degree to which the fluid is carbonated.

### [Container Processing Unit]

The container processing unit 20 can be implemented with a range of configurations, as illustrated in examples 1-6 below. Generally, in examples where the machine 2 comprises a guide portion, in to which a container is inserted and is guided by gravity (e.g. under its own weight) to the container processing unit 20, the container processing unit 20 is arranged with a container holding portion and a closing portion, which are movable between a container receiving position and a container processing position in a depth direction, which is perpendicular (including substantially perpendicular) to a direction of transmission of the guide portion.

Referring to FIGS. 4 and 5, a first example of the container processing unit 20 is for processing of a container arranged as a capsule 6 (a suitable example of a capsule is provided in FIG. 7, which will be discussed) to prepare a beverage. The container processing unit 20 is configured as an extraction unit 32 to extract the beverage from the capsule 6. The extraction unit 32 includes a capsule holding portion 34 and a closing portion 36. The extraction unit 32 is movable to a capsule receiving position (FIG. 4), in which capsule holding portion 34 and a closing portion 36 are arrange to receive a capsule 6 therebetween. The extraction unit 32 is movable to a capsule extraction position (FIG. 5), in which the capsule holding portion 34 and a closing portion 36 form a seal around a capsule 6, and the beverage can be extracted from the capsule 6. The extraction unit 32 can be actuator driven or manually movable between said positions.

The outlet 30 of the fluid conditioning system 22 is arranged as an injection head 38 on the capsule holding portion 34 to inject the conditioned fluid into the capsule 6 in the capsule extraction position, typically under high pressure. A beverage outlet 40 on the closing portion 36 is arranged to capture the extracted beverage and convey it from the extraction unit 32.

The extraction unit 32 is arranged to prepare a beverage by the application of pressurised (e.g. at 10-20 Bar), heated (e.g. at 50-98 degrees C.) fluid to the precursor material within the capsule 6. The pressure is increased over a predetermined amount of time until a pressure of a rupturing portion (not illustrated in FIGS. 4 and 5) of the capsule 6 is exceeded, which causes rupture of said portion and the beverage to be dispensed to the beverage outlet 40.

In variant embodiments, which are not illustrated, although the injection head and beverage outlet are illustrated as arranged respectively on the capsule holding portion and closing portion, they may be alternatively arranged, including: the injection head and beverage outlet are arranged respectively on the closing portion capsule holding portion and; or both on the same portion. Moreover, the extraction unit may include both parts arranged as a capsule holding portion, e.g. for capsules that are symmetrical about the flange, including a Nespresso® Professional capsule. Examples of suitable extraction units are provided in EP 1472156 A1 and in EP 1784344 A1 and provide a hydraulically sealed extraction unit.

In a second example (which is not illustrated) of the container processing unit a similar extraction unit to the first example is provided, however the extraction unit operates at a lower pressure and by centrifugation. An example of a suitable capsule is a Nespresso® Vertuo capsule. A suitable example is provided in EP 2594171 A1. With such an example (or indeed the other examples) a guide portion may be obviated and the container manually loaded into the extraction unit.

In a third example, (which is not illustrated) the capsule processing unit operates by dissolution of a beverage precursor that is selected to dissolve under high pressure and temperature fluid. The arrangement is similar to the extraction unit of the first and second example, however the pressure is lower and therefore a sealed extraction unit is not required. In particular, fluid can be injected into a lid of the capsule and a rupturing portion is located in a base of a storage portion of the capsule. An example of a suitable capsule is a or Nescafé® Dolce Gusto capsule. Examples of suitable extraction units are disclosed in EP 1472156 A1 and in EP 1784344 A1.

In a fourth example, (which is not illustrated) wherein the container is arranged as a packet, the container processing unit implements an extraction unit operable to receive the packet and to inject, at an inlet thereof, fluid from the fluid conditioning system. The injected fluid mixes with precursor material within the packet to at least partially prepare the beverage, which exits the packet via an outlet thereof. An example of such an arrangement is provided in WO2014125123 A1 or in WO2022023578A1.

In a fifth example, (which is not illustrated) the container processing unit is arranged as a mixing unit to prepare a beverage or foodstuff precursor that is stored in a container that is a receptacle, which is for end user consumption therefrom. The mixing unit comprises an agitator (e.g. planetary mixer; spiral mixer; vertical cut mixer) to mix and a heat exchanger to heat/cool the beverage or foodstuff precursor in the receptacle. A fluid supply system may also supply fluid to the receptacle. An example of such an arrangement is provided in WO 2014067987 A1.

In a sixth example, (which is not illustrated) the container processing unit is arranged as a dispensing and dissolution unit. The dispensing and dissolution unit is arranged to extract a single serving portion of beverage or foodstuff precursor from a storage portion of the machine (which can include any multi-portioned container including a packet or box). The dispensing and dissolution unit is arranged to mix the extracted single serving portion with the conditioned fluid from the fluid conditioning system, and to dispense the beverage or foodstuff into a receptacle. An example of such an arrangement is provided in EP14167344A.

### [Second Example of Processing Unit]

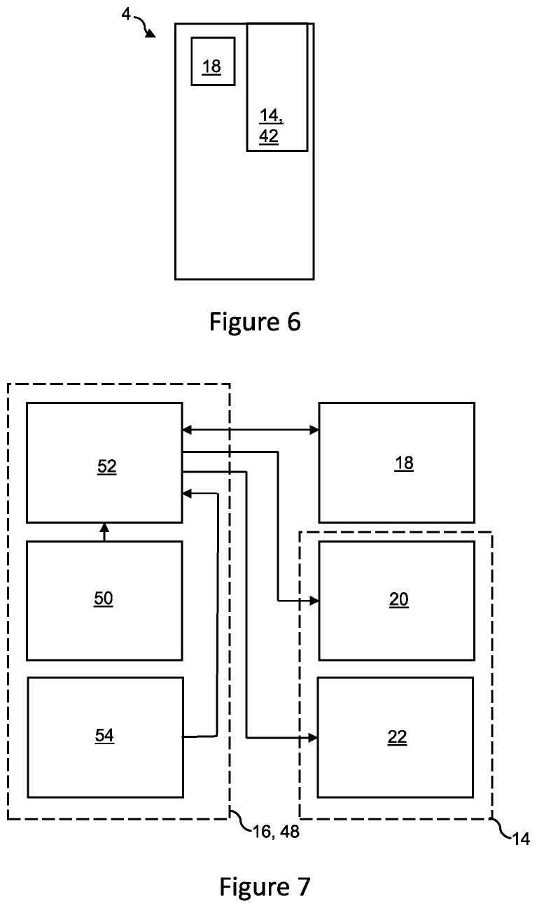

Referring to FIG. 6, in a second example of the processing unit 14, said unit comprises a comprises a loose material processing unit 42.

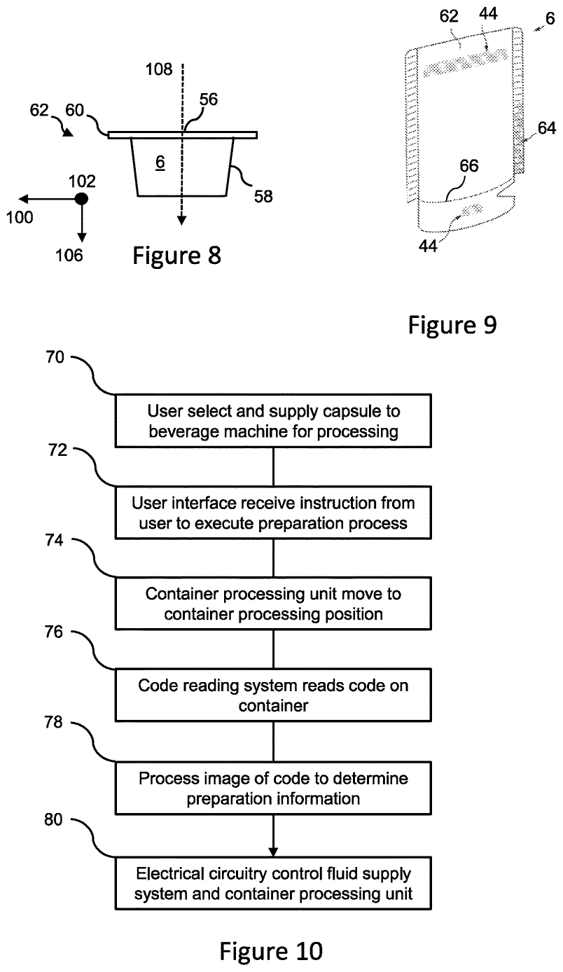

The loose material processing unit 42 is arranged to receive loose pre-precursor material from a container 6 (a suitable example is provided in FIG. 8 as will be discussed) and to process the pre-precursor material to derive the precursor material. The electrical circuitry 16 uses the preparation information read from the container 6 to control the loose material processing unit 42 to execute the preparation process.

A user resents manually the container 6 to a code reading system 18, of the machine 4, to read the code (as will be discussed). The user then opens the container 6 and dispenses the pre-precursor material (not illustrated) arranged therein into the loose material processing unit 42. The loose material processing unit 42 processes the loose pre-precursor material to the precursor material.

In a particular example, the pre-precursor material is coffee beans, and the loose material processing unit 42 is arranged to roast and/or grind the coffee beans to provide a precursor material.

In variant embodiments, which are not illustrated, the loose material processing unit is alternatively configured, including: with a dispensing system to open and dispense the pre-precursor from the capsule for subsequent processing (e.g. it may include a cutting tool to cut open the container and an extractor such as a scop to extract the pre-precursor material); the pre-precursor material may be processed in the container and either dispensed from the container by the aforedescribed example or provided to a user in the container.

### [Code Reading System]

Referring to FIGS. 4 and 5, the code reading system 18 is arranged to read a code 44 arranged on a lid of the container 6. The code reading system 18 is integrated with the extraction unit 32 of first example of the container processing unit 20. The code 44 is read with the extraction unit 32 in the capsule extraction position (as shown in FIG. 4).

The code reading system 18 includes a code reader 46 with an image capturing unit and a reading head housing the image capturing unit to capture a digital image of the code 44. Examples of a suitable image capturing unit include a Sonix SN9S102; Snap Sensor S2 imager; an oversampled binary image sensor; other like system.

The electrical circuitry 18 includes image processing circuitry (not illustrated) to identify the code in the digital image and extract preparation information. An example of the image processing circuitry is a Texas Instruments TMS320C5517 processor running a code processing program.

In variant embodiments, which are not illustrated, the code reading system is separate from the container processing unit including: it is arranged in a channel that the user places the container in and that conveys the container to the container processing unit; it is arranged to read a code on a receptacle, which is positioned to receive a beverage from an beverage outlet of a dispensing and dissolution unit. In further variant embodiments, which are not illustrated, the code reading system is arranged to read a code at a different location of the container, e.g. on a flange or containment portion. In further variant embodiments, which are not illustrated, the code is a one dimensional code and is read by relative movement between the code reader and the code to produce a code signal.

### [Control Electrical Circuitry]

Referring to FIG. 7, the electrical circuitry 16 is implemented as control electrical circuitry 48 to control the processing unit 14 to execute a preparation process. In the embodiment of FIG. 7, for illustrative purposes, the processing unit 14 is exemplified as the first example, which comprises a container processing unit 20 and a fluid supply unit 22.

The electrical circuitry 16, 48 at least partially implements (e.g. in combination with hardware) an: input unit 50 to receive an input from a user confirming that the machine 4 is to execute a preparation process; a processor 52 to receive the input from the input unit 50 and to provide a control output to the processing unit 14, and; a feedback system 54 to provide feedback from the processing unit 54 during the preparation process, which may be used to control the preparation process.

The input unit 50 is implemented as a user interface, which can include one or more of: buttons, e.g. a joystick button or press button; joystick; LEDs; graphic or character LDCs; graphical screen with touch sensing and/or screen edge buttons; other like device; a sensor to determine whether a container has been supplied to the machine by a user.

The feedback system 54 can implement one or more of the following or other feedback control based operations:
a flow sensor to determine a flow rate/volume of the fluid to the outlet 30 (shown in FIG. 3) of the fluid supply system 22, which may be used to meter the correct amount of fluid to the container 6 and thus regulate the power to the pump 26;
a temperature sensor to determine a temperature of the fluid to the outlet 30 of the fluid supply unit 22, which may be used to ensure the temperature of fluid to the container 6 is correct and thus regulate the power to the heat exchanger 28);
a level sensor to determine a level of fluid in the reservoir 24 as being sufficient for a preparation process;
a position sensor to determine a position of the extraction unit 32 (e.g. a capsule extraction position or a capsule receiving position).

It will be understood that the electrical circuitry 16, 44 is suitably adapted for the other examples of the processing unit 14, e.g.: for the second example of the container processing system the feedback system may be used to control speed of rotation of the capsule.

### [Container]

Referring to FIG. 8, a first example of a container 6, that is for use with the first example of the processing unit 14 comprises the container 6 arranged as a capsule 6. The capsule 6 includes a closing member 56 and a body portion 62, which comprises a storage portion 58, and a flange portion 60.

The storage portion 58 includes a cavity for storage of the precursor material (not illustrated). The cavity of the storage portion extends in a depth direction 106 from the flange portion 60. Referring to FIGS. 4 and 5, the storage portion 56 is perforated by the injection head 38 to supply conditioned fluid into the capsule.

The storage portion 58 is formed from a paper based material. The storage portion 58 has a thickness of 0.2 mm. The closing member 56 is formed from a paper based material. The closing member 58 has a thickness of 0.15 mm.

As used herein “paper based” may refer to as being formed at least partially from a thin sheet material produced by mechanically or chemically processing cellulose fibres derived from one or more of: wood; rags; grasses, or; other vegetable sources, in water, draining the water through fine mesh leaving the fibre evenly distributed on the surface, followed by pressing and drying.

The closing member 56 closes and may hermitically seal the storage portion 58 and comprises a flexible membrane. Referring to FIGS. 4 and 5, the closing member 56 is perorated to eject the beverage/foodstuff.

The flange portion 60 is formed integrally with the storage portion. The flange portion 60 is arranged at the junction of the storage portion 58 and closing member 56 and comprise a planar extension of the storage portion 58 that is overlapped by a portion of the closing member that is fixed thereto to hermetically seal the precursor material. The flange portion 60 extends in a plane defined by a lateral direction 102 and a longitudinal direction 100. Hence the closing member is planar in said plane.

The capsule 6 is circular cross sections such that it is rotationally symmetric about axis 108. In this way a user can present the capsule to the machine 2 with any orientation about the axis 108. The capsule 6 has a diameter of 53 mm, which is measured across an outer or inner periphery of the flange portion 60 in said plane of the flange portion 60. The capsule 6 can be configured with different sizes, which are characterised by different depths e.g.: 7 mm; 12 mm; 15 mm; 18 mm, and; 21 mm. The capsule 6 in each size is compatible with the first and second examples of the code reading system 18 as will be discussed.

In variant embodiments, which are not illustrated, the closing member may be arranged as convex or concave with respect to the storage portion. For example, for a convex arrangement, a centre of the closing member may extend into the storage portion in the depth direction by up to 1 mm±10% or 20%. A minimum concavity maybe 0.2 mm. For example, for a concave arrangement, a centre of the closing member may extend away from the storage portion in the counter depth direction by up to 4 mm±10% or 20%. A minimum concavity maybe 0.5 mm.

In variant embodiments, which are not illustrated: the body portion comprises the flange portion formed non-integrally with the storage portion and connected thereto; the body portion comprises the flange portion omitted, e.g. the closing member is wrapped around the storage portion; the container may be a non-rotationally symmetric shape, e.g. square sectioned or other shape; the capsule is alternatively dimensioned, including across an outer or inner periphery of the flange portion is 40-70 mm or 53 mm±10% or 20% and the depth is any of the described depths ±10% or 20%; the thickness of the storage portion may have a thickness of 0.1 to 0.4 mm or 0.2±20% or 30%; the thickness of the closing member may have a thickness of 0.05 to 0.3 mm or 0.15±20% or 30%, and; the storage portion and/or closing member may be made out of or include a different material, e.g. including a plastics or aluminium based material.

Referring to FIG. 9, a second example of a container 6 that is for use with the second example of the processing unit 14 comprises the container 6 arranged as a packet and includes: an arrangement of sheet material 62 joined at peripheral seams 64 defining an internal volume for the storage of the precursor material (not illustrated), and; an opening 66, that a user opens to dispense the precursor material into the loose material processing unit 42.

### [Arrangement of Code]

Referring to FIG. 8, the code 44 code may be arranged on an exterior surface of the container 6 in any suitable position such that it can be read by the code reading system 18.

In an first example, the code 44 is arranged at a central region of the closing member 56. The code can therefore be read by any code reader that is aligned to the centre of the container. In an second example, the code is reproduced over the entire closing member so that it can be read from any exterior position on the closing member 56. With such an arrangement the closing member does not require any specific alignment with the storage portion, which simplifies cutting and assembly processes for the container 6.

In variant embodiments, which are not illustrated, the code can be arranged on the flange portion 60 (including on either side) and on the storage portion 58. The code may also be arranged on the closing member but not on the central region.

In the second example shown in FIG. 9, the code 44 is arranged at various positions on the sheet material 62, including distal the seams 64.

### [Preparation Process]

Referring to FIG. 10, a process for preparing a beverage/foodstuff from precursor material is illustrated:

Block 70: a user supplies a container 6 to the machine 4.

Block 72: the electrical circuitry 16 (e.g. the input unit 50 thereof) receives a user instruction to prepare a beverage/foodstuff from precursor, and the electrical circuitry 16 (e.g. the processor 52) initiates the process.

Block 74: the electrical circuitry 16 controls the processing unit 14 to process the container (e.g. in the first example of the container processing unit 20, the extraction unit 32 is moved from the capsule receiving position (FIG. 4) to the capsule extraction position (FIG. 5)).

Block 76: the electrical circuitry 16 controls the code reading system 18 to provide a digital image of the code 6 of the container.

Block 78: the code processing circuitry of the electrical circuitry 16 processes the digital image to extract the preparation information.

Block 80: the electrical circuitry 16, based on the preparation information, executes the preparation process by controlling the processing unit 14. In the first example of the processing unit this comprises: controlling the fluid conditioning system 22 to supply fluid at a temperature, pressure, and time duration specified in the preparation information to the container processing unit 20.

The electrical circuitry 16 subsequently controls the container processing unit 20 to move from the capsule extraction portion through the capsule ejection position to eject the container 6 and back to the capsule receiving position.

In variant embodiments, which are not illustrated: the above blocks can be executed in a different order, e.g. block 72 before block 70 or block 76 before block 74; some block can be omitted, e.g. where a machine stores a magazine of capsules block 70 can be omitted.

Blocks 76 and 78 may be referred to a code reading and processing process. Block 80 may be referred to as the preparation process. The electrical circuitry 16, includes instructions, e.g. as program code, for the preparation process (or a plurality thereof). In an embodiment the processor 52 implements the instructions stored on a memory (not illustrated).

As part of the preparation process, the electrical circuitry 16 can obtain additional preparation information via the computer network 12 from the server system 8 and/or peripheral device 10 using a communication interface (not illustrated) of the machine.

### [Code General Description]

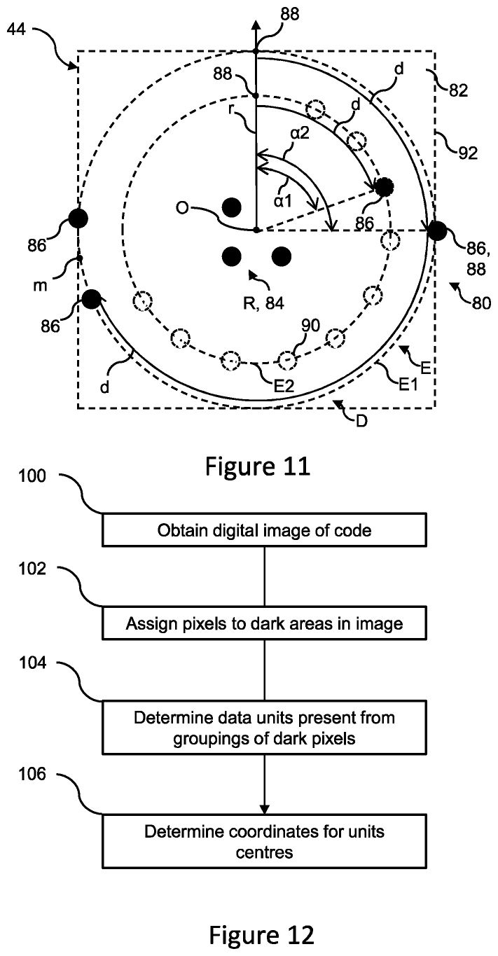

Referring to FIG. 11, the code 44 is formed of a plurality of circular units 80 arranged on a surround 82. The units 80 are a dark colour (e.g. including one of the following: black, dark blue, purple, dark green) and the surround 82 is a comparatively light colour (e.g. including one of the following: white, light blue, yellow, light green) such that there is sufficient contrast for the image capturing unit 46 to distinguish therebetween. The units 80 of the code may be configured to be read in the infra red and/or visible wavebands.

The units 80 are circular in shape. As used herein the term “shape” in respect of the units may refer to an exact shape or an approximation of the actual shape, which can occur to a printing or other manufacturing variations in precision.

In variant embodiments, which are not illustrated: the units are a light colour and the surround is a dark colour; the units have a different shape including one or a combination of the following shapes, triangular, polygon, in particular a quadrilateral such as square or parallelogram; other suitable shape.

The units 80 typically have a unit length of 50-200 μm. As used herein the term “unit length” in respect of a unit 80 may refer to a suitably defined distance of the unit 80, e.g.: for a circular shape the diameter; for a square a side length; for a polygon a distance between opposing or adjacent vertices; for a triangle a hypotenuse. The units 80 are arranged with a precision of about 1 μm.

The units 80 are formed by printing e.g. by means of an ink printer. As an example of printing the ink may be conventional printer ink and the substrate may be: polyethylene terephthalate (PET); aluminium coated with a lacquer (as found on Nespresso Classic capsules) or other suitable substrate.

In variant embodiments, which are not illustrated: the units are alternatively formed, including by embossing, engraving or other suitable means, and; the units are alternatively dimensioned, e.g. a unit length of 80-120 μm.

Referring further to FIG. 11, the units 80 are organised into: a reference portion R to locate and determine an orientation of the code 44, and; a data portion D to store the preparation information.

The units 80 of the code 44, which are arranged as the reference portion R, comprise three reference units 84. The reference units 84 have a unique spatial arrangement in the code 44 to allow the reference portion R to be identified by the electrical circuitry 16 (e.g. with a stored relationship on a memory thereof) in the digital image. The unique spatial arrangement comprises the reference units 84 arrange at three of the vertices of a virtual rectangle (not illustrated), about an origin O at the centre of the rectangle, with specific distances between the reference units 84.

In variant embodiments, which are not illustrated, the reference portion is alternatively implemented, including: as a different arrangement of reference units, e.g. including as a circle or other shape of rectangle; with a different number of reference units, e.g. including as 4 or 5, and; the reference units may have a unique shape that is identifiable from the shape of the other units forming the code.

The arrangement of the reference units 84 enables the definition of a single reference line r at a specific vector relative to said units 84. The reference line r is virtual, and is determined by the electrical circuitry 16 (e.g. with a stored relationship on a memory thereof).

In the particular example, the reference units 84 define, using the right hand rule, a first virtual line (not illustrated) and a second virtual line (not illustrated), wherein: the thumb represents the first virtual line which intersects the centres of two of the refence units 84; the index finger represents the second virtual line which intersects the centres of two of the refence units, one of which being the common to the first virtual line; the second finger is into the plane of the page of the code 44. The reference line r extends from the origin O and is parallel to the first virtual line and is orthogonal to the second virtual line.

In variant embodiments, which are not illustrated, the reference line may be alternatively defined: the may comprise an actual line drawn on the code; it may have an alternative geometric arrangement with respect to the reference units.

Units 80 of the code 44, which are arranged as the data portion D, comprise data units 86. The data units 86 are arranged on an encoding line E that intersects the reference line r. The encoding line E is virtual and is determined by electrical circuitry 16, (e.g. the encoding lines have predefined radii, which are stored on a memory thereof). The centre of the circle of the encoding line E is arranged at the origin O of the reference portion R. The reference line r therefore intersects the encoding line E with a tangent thereto orthogonal to the reference line r. There are two encoding lines E1, E2, each with data units 86.

In variant embodiments, which are not illustrated: other numbers of encoding lines are implemented including 3, 4, or 5; the encoding lines may have non-circular shapes, including rectangular or triangular; the encoding line comprises an actual line drawn on the code.

The encoding line E includes one or more individual data portions, each of which includes a start position 88 and a data unit 86, which is arranged at a distance d along the encoding line E from the start position 88 as a variable to encode a parameter of the preparation information. The start positions 88 are defined virtually and may be determined by electrical circuitry 16 (e.g. the start positions may be stored on a memory thereof). The individual data portions may also include an end position (not illustrated), which defines a maximum allowable distance d of the data unit 80 along the encoding line E from the start position 88. Both the start and end positions are formed virtually.

For the first encoding line E1, the data portion includes two individual data portions: for the first individual data portion the distance d can be any continuous distance from the start position 88 at the reference line r to the first data unit 86 clockwise from the reference line r; for the second individual data portion the distance d can be any continuous distance from the start position 88 at the data unit 86 of the first individual data portion (hence the start position is variable) to the mid-point m between the subsequent two data units 86 in the clockwise direction.

For the second encoding line E2, the data portion includes one individual data portion, for which the distance d can be any one of a plurality of discrete distances, which are illustrated as discrete positions 90 from the start position 88 at the reference line r, with each position associated with a different value of the parameter. In the example there are 10 discrete positions 90.

A incremented distance can be defined as the distance between the start position 88 and an end position divided by the total number of positions (which is 10 for E2) in the data portion D that the data unit 86 may occupy.

In variant embodiments, which are not illustrated: a start position can be arranged at any position on the encoding line, including spaced away from the reference line; there may be multiple start positions on an encoding line, each with an associated data unit; the start position may be formed as part of the code as a unit rather than defined virtually; an encoding line may comprise combinations of parameters encoded by the continuous distance and the discreet positions; more than one or two data units on the encoding line may define the parameter, which can be determined as an average of the positions, and; the data portion can include any suitable number of individual data portions.

The code 44 includes an outer periphery 92 that the units 80 are arranged within. The outer periphery 92 is rectangular in shape and has a dimension of 600-1600 μm, or about 1100 μm. The code 44 may be repeated such that multiple repetitions of the code 44 are arranged within a single digital image, such that one or several best captured repetitions of the code can be selected for processing.

In variant embodiments, which are not illustrated: the outer periphery may be alternatively shaped, including circular; the outer periphery may have alternative sizes, including greater or smaller than the example range. In variant embodiments, which are not illustrated, the data portion alternatively encodes the value of said parameter, including as alphanumeric symbols or other arrangement.

Referring to FIG. 12, with reference to the code of FIG. 11, a code processing process, which is executed by the electrical circuitry 16 (or the code processing circuitry thereof) for extraction of the preparation information includes:

Step 1—Identify locations of units of code

Block 100: obtain digital image of code 44 via the code reading system 118.

Block 102: assign pixels to dark areas in digital image that could represent units 80.

Block 104: if several pixels grouped in proximity of each other then determine a unit 80 as present.

Block 106: for each determined unit determine a centre of pixel grouping by a rule, e.g. feature extraction, to determine a coordinate of a centre of the unit.

Invariant embodiments, which are not illustrated, alternative processing techniques for determining units and there coordinates may be implemented, including other techniques for locating a centre of a unit or identifying a unit as present, e.g. a level of magnification may be implemented so that a single pixel is determined as a unit, and a centre of a unit may be determined as the centre of a pixel.

Step 2—Locate Reference portion and read angles of code

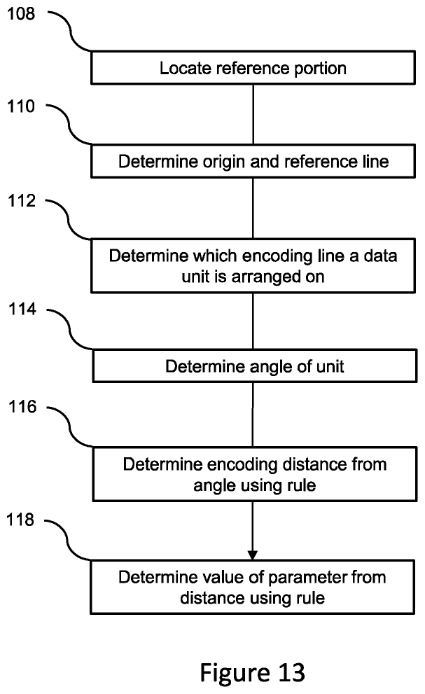

Referring to FIG. 13, with reference to the code of FIG. 11, processing of the code 44 includes:

Block 108: locate reference portion R by searching coordinates of units 80 of code 44 to identify the unique separation and geometric arrangement of reference units 84. This may be implemented by geometric rules including Pythagoras and trigonometry or other suitable rule. Said separation and geometric arrangement can be stored on the electrical circuitry 16 and accessed during searching.

Block 110: for the located reference portion R, define the origin O and the position of reference line r using a stored relationship. The arrangement of the origin and reference line can be stored on the electrical circuitry 16 and mapped onto the coordinates of the located reference portion.

Block 112: for each unit (other than the units of the reference portion) determine based on distance from the origin O which encoding line E the units belong to. The electrical circuitry 16 can store a radii range for each encoding line E and using geometric rules determine the distance of each unit from the origin O and which radii range it falls in.

Block 114: for each unit (other than the units of the reference portion) determine the angle α1, α2 with respect to the reference line r. It is to be noted that the angle is representative of the circumferential distance, and either could be used interchangeably. The angle can be calculated via know geometric relations between the coordinates of the reference line r and a virtual line extending from the origin O and through the associated unit.

Step 3—Determine values of parameters of preparation information.

Referring to FIG. 13, with reference to the code of FIG. 11 processing of the code 44 includes:

Block 116: the encoding distance d is determined for each individual data portion. This is achieved by implementing a set of rules for determining the encoding distance d which are stored by the electrical circuitry 16. This can include the one or more of: the number of individual data portions on each encoding line; the start positions 88 of the individual data portions; if a single unit or multiple units represent a data unit 86, and; other suitable relationships.

For example referring to FIG. 9, the rules for determining the encoding distances d of encoding line E1 include that there are: two individual data portions; the start position 88 of the first individual data portion is at the intersection between the reference line r and the encoding line E1; the start position 88 of the second individual data portion is at the data unit 86 of the first individual data portion; the data unit 86 is of the first individual data portion is represented as a single unit of the code 44; the data unit 86 is of the second individual data portion is represented as a two units of the code 44.

For example referring to FIG. 11, the rules for determining the encoding distance d of encoding line E2 include that there is: a single individual data portion; the start position 88 is at the intersection between the reference line r and the encoding line E2; the data unit 86 is of the first individual data portion is represented as a single unit of the code 44.

Block 118: the encoding distances d for each data portion are converted into a value of a parameter. This is achieved by implementing a set of rules for converting the distance to a value which are stored by the electrical circuitry 16.

For example, for encoding line E1: the first individual data portion may encode a water volume of a brewing process wherein the distance d is any continuous value which is linearly related to the water volume, and; the second individual data portion may encode a time of a brewing process wherein the encoding distance d is any continuous value which is exponentially related to the time.

For example, for encoding line E2: the single individual data portion may encode a water temperature of a brewing process wherein the encoding distance d is a discrete value which incrementally changes by 5 degrees C. for each discrete position 90, and the rule specifies which 5 degree increment is closest to the determined encoding distance d.

In variant embodiments, which are not illustrated, other rules can be implemented, including: other mathematical functions relating the encoding distance to the value of the parameter, and; if an encoding distance is the average of the distance several individual data portions, and other suitable relationships.

### [Code Formation]

### Example 1

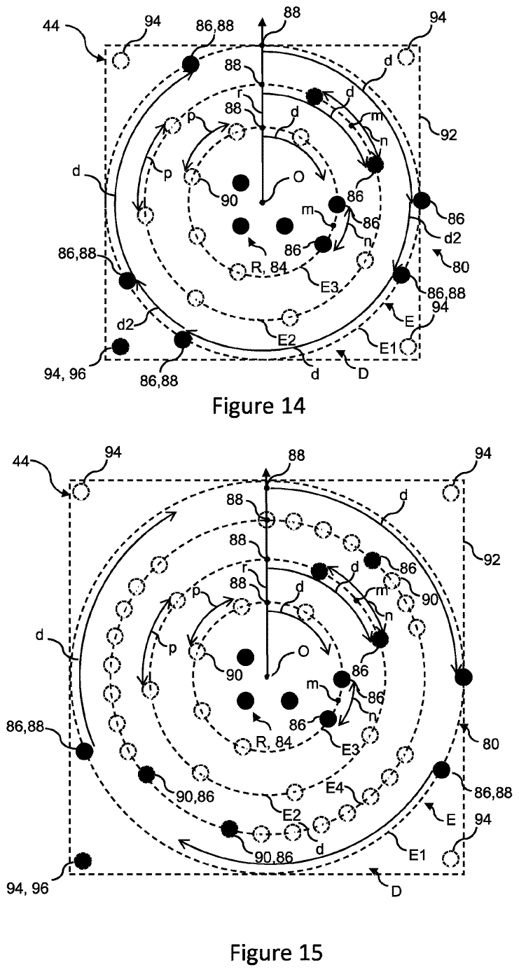

Referring to FIG. 14, in a first example, the code 44 with an outermost encoding line E1 that has the greatest radii and is distalmost the reference portion R encodes three values of the same parameter of the preparation information, which are encoded in a sequence according to an order of use of the parameter, as will be discussed. Each of said values are encoded with a single data unit 86, which are arrangeable at any continuous position d from a start position.

For the first value, this is encoded with the data unit 86 which is at a clockwise position proximal most the reference line r. The start position 88 is the intersection with the reference line r. The encoding distance d is from the reference line r to said data unit 86.

For the second value, this is encoded with the third data unit 86 in the clockwise position from the reference line r. The start position 88 is the second data unit 86 in the clockwise position from the reference line r. The encoding distance d is from said second data unit 86 to the third data unit 86.

For the third value, this is encoded with the fifth data unit 86 in the clockwise position from the reference line r. The start position 88 is the fourth data unit 86 in the clockwise position from the reference line r. The encoding distance d is from said fourth data unit 86 to the fifth data unit 86.

Although not illustrated, an end position for each value defines a maximum encoding distance d for each of the three values. The distance from the start position 88 to the end position is equal for all three values, such that a similar degree of accuracy is provided for each value.

The first, second and third values are a time duration for which one or more components of a processing unit of the machine is operated. The component is one or more of: a mixer of a mixing unit of the processing unit; a heat exchanger of a fluid conditioning system of the processing unit; a pump of the fluid conditioning system; a flow path control system of the fluid conditioning system (e.g. a valve that when actuated enables fluid from the fluid conditioning system to bypass the container in the processing unit and be outlet directly as part of the beverage/foodstuff); other like component.

A further value of a parameter is encoded as the encoding distance d2 between the data unit 86 of the adjacent value in the counter clockwise direction from and to the data unit 86 at the start position 88. As illustrated two encoding distances d2 are encoded between the encoding of the second and first value and the encoding of the third and second value. The further value is a time duration between operations for which said components is not operated. The further value and value therefore encode an on/off sequence according to an order of use.

The outermost encoding line E3 encodes only values of parameters of the preparation information with data units at any continuous distance from the associated start position (e.g. no encoding of binary information or of units at predetermined positions is present on the outermost encoding line).

In variant embodiments, which are not illustrated: other numbers of values (or further values) of the same parameter may be encoded on the outer encoding line, e.g. 2 or 4; the values may be encoded in an order other than the order of use; the outer encoding line may also encode binary information e.g. as a part of an identifier, as will be discussed; values other than time may be encoded.

In variant embodiments, a data unit at the start position may be omitted, e.g. the start position is either a predetermined distance in the clockwise direction from the data unit encoding the preceding value, or is a data unit for the preceding value.

An inner encoding line E3 that has the least radii and is proximal most the reference portion R encodes a value of a parameter, which is encoded with an encoding distance d as an average m distance of two data units 86, both of which are arrangeable at a position from a start position 88, which is at the intersection of the encoding lie E3 with the reference line r.

The inner encoding line E3 also encodes binary information of the preparation information, which is encoded as an absence or presence or a unit at each of five predetermined positions 90 (non of which are illustrated as including a data unit). The predetermined positions 90 are fixed with respect to the proximal most of the two data units 86 (which has the greatest clockwise position) on the inner encoding line E3 that encode the parameter as previously discussed.

On the inner encoding line E3, the distance between the two units 86 is a fixed distance n, which is stored by the electrical circuitry 16. The distance p between each of the five predetermined positions 90 is a fixed equal distance, which is stored by the electrical circuitry 16, and which is different to that between the two units 86. In this way, the predetermined positions 90 can be distinguished from the units 86. A clockwise distance from said proximal most data unit 86 and the closest predetermined position 90 can be any distance other than the distance n between the data units 86, e.g. it can be distance p.

In variant embodiments, which are not illustrated, there are other numbers of predetermined positions, e.g. 2 or 4 or 6 or 8 etc.

An intermediate encoding line E2 adjoining the innermost encoding line E3 (e.g. it is directly next to with no other encoding lines therebetween) encodes preparation information in the same format as the innermost encoding line E3. That is, a value of a parameter, which is encoded as an average distance of two data units 86, both of which are arrangeable at a position from a start position 88, and binary information, which is encoded as an absence or presence or a unit at a predetermined position 90 with respect to one of the units encoding the parameter on the intermediate encoding line. The same detailed description and potential variants as for the innermost encoding line E3 therefore applies to the intermediate encoding line E2, which for brevity is not repeated.

The binary information of the innermost encoding line E3 and intermediate encoding line E2 and comprises an identifier, which is distributed over both of said lines.

The binary information is also encoded as an absence or presence of a unit at predetermined positions 94 at vertices that define a square, with said vertices outside the outermost encoding line E1, the binary information also comprises the identifier.

In the example where there are five predetermined positions 90 on both the encoding lines E2, E3 and four predetermined positions outside the outermost encoding line E1, the identifier is 14 bits in length. The identifier can be used to look up additional preparation information (e.g. including values of parameters) stored on the electronic circuitry 16.

In variant embodiments, which are not illustrated: the predetermined positions outsider the outermost encoding line may be omitted; the identifier does not require distributing over the three different arrangements of the predetermined positions, e.g. it may be arranged on one or more, e.g. just the inner encoding line.

Both of the two data units 86 that encode the value of the parameter, on the innermost encoding line E3 and on the intermediate encoding line E2 adjoining the innermost encoding line, are arrangeable at one of a predetermined number of predetermined positions (not illustrated) arranged relative the start position 88 with each position designate a different value of the parameter. Hence the average encoding distance m also occupies only predetermined distances. Said predetermined positions are arranged sequentially with each designating an increasing magnitude of the parameter by clockwise position, e.g. there maybe 10 predetermined positions, which encode sequentially a numerical value of 0 to 18 in increments of 2.

In variant embodiments, which are not illustrated the predetermined positions may encode other maximum and minimum values with different increments, the predetermined positions may not be in sequence or may decrease in magnitude of the parameter by clockwise position.

In variant embodiments, which are not illustrated: both of the two data units that encode the value of the parameter, on the innermost encoding line and on the intermediate encoding line adjoining the innermost encoding line are arrangeable at any continuous position from a start position (e.g. up to an end position).

The parameter encoded by the two data units of the inner most encoding line and/or of the intermediate encoding line, which is proximal most the innermost encoding line, may be: a parameter associated with a closing force of an extraction unit (e.g. a force between a capsule holding portion and a closing portion); a displacement position of the extraction unit (e.g. a displacement of the capsule holding portion and/or the closing portion); a volume of fluid or fluid flow rate applied by a pump of a fluid condition system of the processing unit; a temperature of a heat exchanger of the fluid conditioning system, etc.

### Example 2

Referring to FIG. 15, the outermost encoding line E3, inner most encoding line E1 and intermediate encoding line E2 are as described for the first example, including the associated variants, which for brevity are not described.

The second example includes a second intermediate encoding line E4, which is arranged between the outermost encoding line E1 and the intermediate encoding line E2.

The second intermediate encoding line E4 encodes two values of the same parameter of the preparation information, which are encoded in a sequence according to an order of use of the parameter, as will be discussed. Each of said values are encoded with a single data unit 86, which are arrangeable at any one of a predefined number of discrete positions 90, with each position designate a different value of the parameter.

The second intermediate encoding line E4 also encodes a value of a further parameter of the preparation information. The values is encoded with a single data unit 86, which is arrangeable at any one of a predefined number of discrete positions 90, with each position designate a different value of the parameter.

For the first value of the same parameter, there are 8 predetermined positions 90, which are equidistant to each other, with a first predetermined position 90 arranged at the start position 88, which is at the intersection of the second intermediate encoding line E4 with the reference line r, and the eighth predetermined position 90 arranged at the end position. In the example, the data unit 86 is arranged at the fifth predetermined position 90.

For the second value of the same parameter, there are 8 predetermined positions 90, which are equidistant to each other, with a first predetermined position 90 arranged at a predetermined distance from the start position 88, and the eighth predetermined position 90 arranged at the end position. In the example the data unit 88 is arranged at the eighth predetermined position 90.

For the further value of the further parameter, there are 9 predetermined positions 90, which are equidistant to each other, with a first predetermined position 90 arranged at a predetermined distance from the start position 88, and the nineth predetermined position arranged at the end position. In the example the data unit is arranged at the first predetermined position 90.

The distance along the encoding line E4 between the predetermined positions 90 for the first, second, and further value are all equal. To enable more convenient identification of where predetermined positions 90 for the first, second, and further values begin and end, the distance between adjoining start and end positions for the different values is different to the aforesaid equidistant distance between the predetermined positions 90 for the data units.

Said predetermined positions are arranged sequentially with each designating an increasing magnitude of the parameter by clockwise position, e.g. for the 8 predetermined positions they encode sequentially a numerical value of 0 to 14 in increments of 2.

In variant embodiments, which are not illustrated the predetermined positions may encode other maximum and minimum values with different increments, the predetermined positions may not be in sequence or may decrease in magnitude of the parameter by clockwise position; there are other numbers of predetermined positions.

In variant embodiment, which are not illustrated: there are other numbers of values encoded in the same way on the second intermediate encoding line, e.g. 2, 4, 5; in the second example the intermediate encoding line E2 may be omitted; the values encoded on the second intermediate encoding line may all be for the same parameter or a different parameter or with some of the same parameter as illustrated; one or more of the values for the second intermediate encoding line may be encoded continuously as discussed for the outermost encoding line; there may be a different number of predetermined position for the values, generally where the same value is encoded there are a same number of predetermined positions as in the example where there are eight predetermined positions for the first and second value; the parameters as described as encoded by the second intermediate encoding line may be arranged on other encoding lines, e.g. on the outermost or innermost encoding line.

The first value and second value and further value of the parameters encoded by the second intermediate encoding line E4 are a setting of the component of the processing unit when operated (said operation of a component was discussed above for the outermost encoding line). The setting for example may be a magnitude of operation (e.g. a temperature of the heat exchanger or a constant flow rate value of the pump or a flow control value associated with the fluid conditioning system) and/or a frequency of operation (e.g. a pulsing frequency of the thermal exchanger or the pump).

The two or more values of the same parameter encoded by the second intermediate encoding line E4 are arranged in order to correspond and order of use to the two of more values of the parameter on the outermost encoding line E1. For example, the first value on the second intermediate encoding line E4 is a setting for the first operation time encoded on the outermost encoding line E1 and so on. The two or more values of the same parameter of the intermediate encoding line encode a flow rate of a pump of a fluid conditioning system of a processing unit, or a temperature of the thermal exchanger of the fluid conditioning system.

In variant embodiments, which are not illustrated: other parameters are encoded to those discussed; the ordering of the two or more values of the same parameter encoded by the second intermediate encoding line are arranged in order not to correspond and order of use to the two of more values.

Whilst the code is illustrated herein as being arranged on the container, it will be appreciated that the code can be formed integrally on the container or formed on a separate substrate, e.g. an attachment (not illustrated), which can be attached to: the container, e.g. by an adhesive or other means or; to the machine, e.g., as a tab for arrangement between the container and the code reader so that the existing code reading arrangement may be used, or; other component, e.g. including a hand held component that is arranged for a user to present to a code reader of the machine, which may be suitably arranged for manual code reading.

The attachment may alternatively be configured for attachment to the machine, e.g. via a clip or bracket, so that the same code is read independent of the container that is read. The attachment may position the code (or codes) between the container and code reader such that the machine reads the codes as if they were positioned on the container.

It will be appreciated that any of the disclosed methods (or corresponding apparatuses, programs, data carriers, etc.) may be carried out by either a host or client, depending on the specific implementation (i.e. the disclosed methods/apparatuses are a form of communication(s), and as such, may be carried out from either ‘point of view’, i.e. in corresponding to each other fashion). Furthermore, it will be understood that the terms “receiving” and “transmitting” encompass “inputting” and “outputting” and are not limited to an RF context of transmitting and receiving radio waves. Therefore, for example, a chip or other device or component for realizing embodiments could generate data for output to another chip, device or component, or have as an input data from another chip, device or component, and such an output or input could be referred to as “transmit” and “receive” including gerund forms, that is, “transmitting” and “receiving”, as well as such “transmitting” and “receiving” within an RF context.

As used in this specification, any formulation used of the style “at least one of A, B or C”, and the formulation “at least one of A, B and C” use a disjunctive “or” and a disjunctive “and” such that those formulations comprise any and all joint and several permutations of A, B, C, that is, A alone, B alone, C alone, A and B in any order, A and C in any order, B and C in any order and A, B, C in any order. There may be more or less than three features used in such formulations.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

Unless otherwise explicitly stated as incompatible, or the physics or otherwise of the embodiments, example or claims prevent such a combination, the features of the foregoing embodiments and examples, and of the following claims may be integrated together in any suitable arrangement, especially ones where there is a beneficial effect in doing so. This is not limited to only any specified benefit, and instead may arise from an “ex post facto” benefit. This is to say that the combination of features is not limited by the described forms, particularly the form (e.g. numbering) of the example(s), embodiment(s), or dependency of the claim(s). Moreover, this also applies to the phrase “in one embodiment”, “according to an embodiment” and the like, which are merely a stylistic form of wording and are not to be construed as limiting the following features to a separate embodiment to all other instances of the same or similar wording. This is to say, a reference to ‘an’, ‘one’ or ‘some’ embodiment(s) may be a reference to any one or more, and/or all embodiments, or combination(s) thereof, disclosed. Also, similarly, the reference to “the” embodiment may not be limited to the immediately preceding embodiment.

As used herein, any machine executable instructions, or compute readable media, may carry out a disclosed method, and may therefore be used synonymously with the term method, or each other.

The foregoing description of one or more implementations provides illustration and description, but is not intended to be exhaustive or to limit the scope of the invention to the precise form disclosed. Modifications and variations are possible in light of the above teachings or may be acquired from practice of various implementations of the present disclosure.

### LIST OF REFERENCES

2 System
   4 Machine
      14 Processing unit
         20 Container processing unit (first example)
         32 Extraction unit
         34 Capsule holding portion
         36 Closing portion
         38 Injection head
         40 Beverage outlet
         22 Fluid conditioning system
         24 Reservoir
         26 Pump
         28 Heat exchanger
         30 Outlet
         42 Loose material processing unit (second example)
      16 Electrical circuitry
         48 Control electrical circuitry
         50 Input unit
         52 Processor
         54 Feedback system
      18 Code reading system
         46 Image capturing unit
   6 Container
      Capsule—Example 1
      56 Lid portion
         44 Code
         80 Units
         R Reference portion
         84 Reference units
         r Reference line
         O Origin
         D Data portion
         86 Data units
         E Encoding line
         d Distance
         88 Start position
         90 Discrete positions
         I Code Identifying portion
         94 Discrete position
         96 Identifying units
         82 Surround
         92 Outer periphery
      58 Containment portion
      60 Flange portion
      Packet—Example 2
      62 Sheet material
      64 Seams
      68 Opening
   8 Server system
   10 Peripheral device
   12 Computer network

1: A container for containing a precursor material for use with a machine for preparing a beverage and/or foodstuff or a precursor thereof, the container including a machine-readable code storing preparation information for use with a preparation process performed by the machine, the code comprising:
a reference portion to locate the code; and
a data portion to store the preparation information, wherein the reference portion comprises reference units arranged to uniquely define a linear virtual reference line, wherein the data portion comprises data units which at least partially encode values of parameters of the preparation information as geometric distances of the data units from a start position along each of a plurality of virtual encoding lines,
wherein the plurality of virtual encoding lines are circular and are arranged to intersect the linear virtual reference line, and an innermost encoding line of the plurality of virtual encoding lines has a smaller radii than an outermost encoding line of the plurality of virtual encoding lines,
wherein:
1) the outermost encoding line encodes two or more values of the same parameter, which are encoded in a sequence according to an order of use of the parameter in the preparation process, each of the two or more values being encoded with a single data unit arrangeable at any continuous position from a start position;
2) the innermost encoding line encodes a value of a parameter, which is encoded as an average distance of two data units from a start position; and
3) the innermost encoding line encodes binary information of the preparation information, which is encoded as an absence or presence of a unit at a predetermined position with respect to one of the units encoding the parameter on the innermost encoding line.

2: The container of claim 1, wherein each of the two or more values of the same parameter encoded on the outermost encoding line are a time duration for which one or more components of a processing unit of the machine is operated,
and the start position associated with a value comprises a data unit, and a distance between the start position and a data unit encoding an adjacent value encodes a time duration between operations for which the component is not operated.

3: The container of claim 2, wherein the one or more components comprise one or more of: a mixer of a mixing unit of the processing unit; a heat exchanger of a fluid conditioning system of the processing unit; a pump of the fluid conditioning system of the processing unit; or a flow path control unit of the fluid conditioning system.

4: The container of claim 2, wherein the plurality of virtual encoding lines comprises an intermediate encoding line adjoining the outermost encoding line, wherein the intermediate encoding line encodes a value of a further parameter which is encoded with a single data unit which is: (a) arrangeable at one of a predetermined number of positions arranged relative a start position with each position designate a different value of the parameter, (b) is arrangeable at any continuous position from a start position.

5: The container of claim 2, wherein the further parameter of the intermediate encoding line adjoining the outermost encoding line encodes a setting of the one or more components when operated for each of the operations.

6: The container of claim 1, wherein the plurality of virtual encoding lines comprises an intermediate encoding line adjoining the outermost encoding line, wherein the intermediate encoding line encodes two or more values of the same parameter, the values each being encoded with a single data unit which is: (a) arrangeable at one of a predetermined number of positions arranged relative a start position with each position designate a different value of the parameter or (b) is arrangeable at any continuous position from a start position.

7: The container of claim 6, wherein the two or more values of the same parameter are arranged to correspond to an order of use to the two of more values of the parameter on the outermost encoding line.

8: The container of claim 6, wherein the two or more values of the same parameter of the intermediate encoding line is a flow rate of a pump of a fluid conditioning system of a processing unitor a temperature of the thermal exchanger of the fluid conditioning system.

9: The container of claim 1, wherein the plurality of virtual encoding lines comprises an intermediate encoding line adjoining the innermost encoding line, wherein the intermediate encoding line encodes a value of a parameter, which is encoded as an average distance of two data units from a start position on the intermediate encoding line, and
the intermediate encoding line encodes binary information, which is encoded as an absence or presence of a unit at a predetermined position with respect to one of the units encoding the parameter on the intermediate encoding line, and
the binary information comprises an identifier which is distributed over the innermost encoding line and the intermediate encoding line.

10: The container of claim 9, wherein the binary information is additionally encoded as an absence or presence of a data unit at vertices that define a square, with the vertices outside the outermost encoding line, and the binary information comprises the identifier.

11: A substrate for attachment to a container for containing a precursor material for use with a machine for preparing a beverage and/or foodstuff or a precursor thereof or for attachment to the machine, the substrate comprising a machine-readable code storing preparation information for use with a preparation process performed by the machine, the code comprising:
a reference portion to locate the code; and
a data portion to store the preparation information, wherein the reference portion comprises reference units arranged to uniquely define a linear virtual reference line, wherein the data portion comprises data units which at least partially encode values of parameters of the preparation information as geometric distances of the data units from a start position along each of a plurality of virtual encoding lines,
wherein the plurality of virtual encoding lines are circular and are arranged to intersect the reference line, and an innermost encoding line of the plurality of virtual encoding lines has a smaller radii than an outermost encoding line of the plurality of virtual encoding lines,
wherein:
1) an outermost encoding line encodes two or more values of the same parameter, which are encoded in a sequence according to an order of use of the parameter in the preparation process, each of the two or more being encoded with a single data unit arrangeable at any continuous position from a start position;
2) an innermost encoding line of the plurality of virtual encoding lines encodes a value of a parameter, which is encoded as an average distance of two data units from a start position; and
3) the innermost encoding line encodes binary information of the preparation information, which is encoded as an absence or presence of a unit at a predetermined position with respect to one of the units encoding the parameter on the innermost encoding line.

12: A machine for preparing a beverage and/or foodstuff or a precursor thereof, the machine including:
a code reading system to read a code of a container;
a processing unit for processing precursor material of the container; and
electrical circuitry to control the processing unit based on preparation information read from the code,
the electrical circuitry configured to execute steps of:
locating a reference portion of the code;
locating a data portion of the code using a linear line defined by the reference portion;
reading from an outermost circular encoding line of the data portion, two or more encoded values of a same parameter of the preparation information, the values encoded in a sequence according to an order of use of the parameter, the values being encoded as a single data unit arrangeable at any continuous position from a start position on the encoding line as a geometric distance along the encoding line;
reading from an innermost circular encoding line of a data portion, an encoded value of a parameter of the preparation information, the value encoded as an average distance of two data units, both of which are arranged from a start position on the encoding line as a geometric distance along the encoding line; and
reading on the innermost circular encoding line, binary information of the preparation information, which is encoded as an absence or presence of a unit at a predetermined position on the encoding line with respect to one of the units encoding the parameter on the innermost encoding line.

13: A system comprising a machine for preparing a beverage and/or foodstuff or a precursor thereof, the machine including:
a code reading system to read a code of a container;
a processing unit for processing precursor material of the container; and
electrical circuitry to control the processing unit based on preparation information read from the code,
the electrical circuitry configured to execute steps of:
locating a reference portion of the code;
locating a data portion of the code using a linear line defined by the reference portion;
reading from an outermost circular encoding line of the data portion two or more encoded values of a same parameter of the preparation information, the two or more values encoded in a sequence according to an order of use of the parameter, the values being encoded as a single data unit arrangeable at any continuous position from a start position on the encoding line as a geometric distance along the encoding line;
reading from an innermost circular encoding line of a data portion, an encoded value of a parameter of the preparation information, the value encoded as an average distance of two data units, both of which are arranged from a start position on the encoding line as a geometric distance along the encoding line; and
reading on the innermost circular encoding line, binary information of the preparation information, which is encoded as an absence or presence of a data unit at a predetermined position on the encoding line with respect to one of the units encoding the parameter on the innermost encoding line;
wherein system further comprises the container.

14. (canceled)

15: A method of encoding preparation information with a code, the method comprising:
arranging reference units of the code to define a reference portion to locate the code, wherein the reference portion is arranged to define a linear virtual reference line;
encoding, on an outermost circular encoding line of a data portion, two or more values of a same parameter of the preparation information, the two or more values encoded in a sequence according to an order of use of the parameter, the two or more being encoded as a single data unit arrangeable at any continuous position from a start position on the encoding line as a geometric distance along the encoding line;
encoding, on an innermost circular encoding line of the data portion, a value of a parameter of the preparation information, the value encoded as an average distance of two data units, both of which are arranged from a start position on the encoding line as a geometric distance along the encoding line; and
encoding, on the innermost circular encoding line, binary information of the preparation information, which is encoded as an absence or presence of a unit at a predetermined position on the encoding line with respect to one of the units encoding the parameter on the innermost encoding line.

16: A method of reading preparation information from a code for use in a preparation process, in which a machine is controlled based on the preparation information to prepare a beverage and/or foodstuff or precursor thereof, the method comprising:
locating a reference portion of the code;
locating a data portion of the code using a linear line defined by the reference portion;
reading from an outermost circular encoding line of the data portion, two or more encoded values of a same parameter of the preparation information, the values encoded in a sequence according to an order of use of the parameter, the values being encoded as a single data unit arrangeable at any continuous position from a start position on the encoding line as a geometric distance along the encoding line;
reading from an innermost circular encoding line of a data portion, an encoded value of a parameter of the preparation information, the value encoded as an average distance of two data units, both of which are arranged from a start position on the encoding line as a geometric distance along the encoding line; and
reading on the innermost circular encoding line binary information of the preparation information, which is encoded as an absence or presence of a unit at a predetermined position on the encoding line with respect to one of the units encoding the parameter on the innermost encoding line.

17. (canceled)

18. (canceled)
